(19) United States
(12) Patent Application Publication
(10) Pub. No.: US 2020/0112330 A1
(43) Pub. Date: Apr. 9, 2020

(54) CASE FOR PORTABLE DEVICES

(71) Applicant: SOLVAY SPECIALTY POLYMERS ITALY S.P.A., Bollate (IT)

(72) Inventors: Antonio Angelo RUSSO, Milano (IT); Lionel DE BEAUFFORT, Tervuren (BE)

(21) Appl. No.: 16/315,937

(22) PCT Filed: Jul. 4, 2017
(86) PCT No.: PCT/EP2017/066584

§ 371 Date: Jan. 7, 2019

(30) Foreign Application Priority Data
Jul. 7, 2016 (EP) 16178298.2

(51) Int. Cl. H04B 1/3888; C08G 18/10; C08G 18/50; C08G 18/32; C08G 18/40; C08G 18/44; C08G 18/76; C08L 75/04

(52) U.S. Cl. CPC H04B 1/3888; C08G 18/10; C08G 18/5015; C08L 75/04; C08G 18/4018; C08G 18/44; C08G 18/7671; C08G 18/3206

(57) ABSTRACT

The present invention relates to a case for a portable electronic device, made from a composition comprising a fluorinated thermoplastic polyurethane polymer.

### CROSS-REFERENCE TO RELATED APPLICATIONS

This application claims priority from European application No. 16178298.2 filed on 7 Jul. 2016, the whole content of this application being incorporated herein by reference for all purposes.

### TECHNICAL FIELD

The present invention relates to a case for a portable electronic device, made from a composition comprising a fluorinated thermoplastic polyurethane polymer.

### BACKGROUND ART

Following the introduction of portable electronic devices, such as smartphones, media players, laptop computers and the like, cases designed to receive and hold them were introduced in order to protect them for example from drops, abrasions and stains.

Cases for portable electronic devices have been disclosed in several patents and patent applications, such as for example WO 2011/053740 (BENLKIN INTERNATION, INC.), WO 2013/043462 (SPECULATIVE PRODUCT DESIGN, LLC.), WO 2014/145262 (MAV IP LLC.) and US 2015/0097009 (THULE ORGANIZATION SOLUTIONS, INC.).

Cases for portable electronic devices are typically made from hydrogenated thermoplastic polyurethane polymers (H-TPU) because they are more durable, elastic, and stronger than silicon or hydrocarbon cases. A waterproof cover for a mobile phone, wherein the cover body is made of polyurethane is disclosed for example in US 20110312394 (DESIGN TONG CO., LTD.).

Heat processable elastomeric polyurethanes comprising (per)fluoropoly-ether blocks were disclosed for example in U.S. Pat. No. 5,332,798 (AUSIMONT S.P.A.).

U.S. Pat. No. 4,540,765 (BAYER AKTIENGESELLSCHAFT) discloses a coating for textile fabrics and fibers, to render their surface repellent to oil and/or water. To this aim, a coating with polyurethane perfluoroalkyl ligands is provided. A final step comprising heating is performed to remove the end blocks and effects chemical surface onto on the surface. It is a matter of fact that this document discloses a coating (or finishing) for certain articles, wherein the coating is made from a composition comprising a polyurethane perfluoroalkyl compound, without however providing any disclosure or suggestion of any article made from such a polymer.

### SUMMARY OF INVENTION

The Applicant perceived the need of providing a new polymeric material that can be useful for the manufacture of cases, notably for portable electronic devices, characterized by having improved properties when compared to hydrogenated thermoplastic polyurethane polymers (H-TPU), notably improved resistance to stain and finger-prints, chemical and wear resistance, low temperature flexibility, silky feel and mechanical properties.

Thus, in a first aspect, the present invention relates to a case configured to hold at least one part of a mobile media device, said case being made from a composition [composition (C)] comprising at least one fluorinated polyurethane [F-TPU polymer], said F-TPU polymer comprising recurring units derived from:

[monomer (a)] at least one diol selected from the group comprising poly-ether type diol, poly-ester type diol, polybutadien-diol and polycarbonate-diol;

[monomer (b)] at least one hydroxy-terminated (per)fluoropolyether polymer [PFPE polymer];

[monomer (c)] at least one aromatic, aliphatic or cycloaliphatic diisocyanate; and

[monomer (d)] at least one aliphatic, cycloaliphatic or aromatic diol having from 1 to 14 carbon atoms.

The Applicant has surprisingly found that the case made from said composition (C) show a soft silky feeling to the touch, without the addition of plasticizer agents to said composition (C). This provides an advantage from the toxicological point of view, as the plasticizers can migrate of the surface of the object and from there to the skin of the user, thus resulting in possible problems of reddening of the skin, irritation and allergy.

In addition, the Applicant surprisingly found that the case made from composition C as defined above shows improved resistance to stain and an increased ease of cleaning, when compared to panels made from hydrogenated thermoplastic polyurethane (H-TPU) polymers.

### BRIEF DESCRIPTION OF DRAWINGS

FIG. 1 is a front, right isometric view illustrating the case according to a first embodiment of the present invention.

FIG. 2 is a front perspective view illustrating the case according to a second embodiment of the present invention.

FIG. 3 is a perspective view illustrating the case according to a third embodiment of the present invention.

### DESCRIPTION OF EMBODIMENTS

For the purposes of the present description:
the term “(per)fluoropolyether” is intended to indicate a “fully or partially fluorinated polyether”;
the expression “(per)fluoropolyoxyalkylene chain” is intended to indicate a partially or fully fluorinated, straight or branched, polyoxyalkylene chain;
the use of parentheses before and after symbols or numbers identifying compounds, chemical formulae or parts of formulae has the mere purpose of better distinguishing those symbols or numbers from the rest of the text and hence said parentheses can also be omitted;
the term “case” is intended to indicate an article, such as for example a container, designed to hold or protect another object, such as for example a portable electronic device or at least a part, such as a corner or an edge, of said portable electronic device;
the expression “portable electronic device” is intended to include any type of device that requires interactivity with an user and can be carried by hand or in a bag, Such as for example smartphones, music players, video players, game players, laptop computers, tablet computers, walkie-talkies and the like.

Preferably, the F-TPU polymer is a block copolymer, i.e. a polymer comprising blocks (also referred to as “segments”), each block comprising recurring units deriving from monomer (a), monomer (b), monomer (c) or monomer (d), as defined above.

Preferably, said F-TPU polymer has an average number molecular weight of from 30,000 to about 70,000 Da.

Preferably, said F-TPU polymer has a melting point (Tₘ) of from about 120° C. to about 240° C.

Preferably, said at least one monomer (a) has an average number molecular weight of from 500 to 4,000 Da, more preferably of from 1,000 to 4,000.

Preferably, said at least one monomer (a) is selected in the group comprising poly(ethylene)glycol, poly(propylene)glycol, poly(tetramethylen)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol. Poly(tetramethylen)glycol, poly-caprolactone-diol and polycarbonate-diol being particularly preferred.

Preferably, said at least one monomer (b) is a hydroxy-terminated (per)fluoropolyether polymer [PFPE polymer], i.e. a polymer comprising a (per)fluoropolyoxyalkylene chain [chain (R_{pf})] having two chain ends, wherein one or both chain ends terminates with at least one —OH group.

Preferably, at least one chain end of said chain (R_{pf}) terminates with a group of formula:

—CH₂(OCH₂CH₂)ₜ—OH (I)

wherein

t is 0 or from 1 to 5.

More preferably, both chain ends of said chain (R_{pf}) terminate with a group of formula (I) as defined above.

Preferably, said chain (R_{pf}) is a chain of formula

—O-D-(CFX^{#})_{z1}-O(R_{f})(CFX^{*})_{z2}-D*-O—

wherein

z1 and z2, equal or different from each other, are equal to or higher than 1;

X^{#} and X*, equal or different from each other, are —F or —CF3, provided that when z1 and/or z2 are higher than 1, X^{#} and X* are —F;

D and D*, equal or different from each other, are an alkylene chain comprising from 1 to 6 and even more preferably from 1 to 3 carbon atoms, said alkyl chain being optionally substituted with at least one perfluoroalkyl group comprising from 1 to 3 carbon atoms;

(R_{f}) comprises, preferably consists of, repeating units R°, said repeating units being independently selected from the group consisting of:

(i) —CFXO—, wherein X is F or CF₃;

(ii) —CFXCFXO—, wherein X, equal or different at each occurrence, is F or CF₃, with the proviso that at least one of X is —F;

(iii) —CF₂CF₂CW₂O—, wherein each of W, equal or different from each other, are F, Cl, H;

(iv) —CF₂CF₂CF₂CF₂O—;

(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂ O—, —CF₂CF₂CF₂CF₂O—, with each of each of X being independently F or CF₃ and T being a C₁—C₃ perfluoroalkyl group.

More preferably, chain (R_{f}) is selected from the following formulae (R_{f}-a) to (R_{f}-c):

(R_{f}-a)—(CF₂O)ₙ(CF₂CF₂O)ₘ(CF₂CF₂CF₂O)ₚ(CF₂CF₂CF₂CF₂O)_{q}—

wherein m, n, p, q are 0 or integers selected in such a way as chain R_{f} meets the above number average molecular weight requirement, with the proviso that if, p and q are simultaneously 0, n is not 0; when m is other than 0, the m/n ratio is preferably between 0.1 and 20; when (m+n) is other than 0, (p+q)/(m+n) is preferably between 0 and 0.2;

(R_{f}-b)—(CF₂CF(CF₃)O)ₐ(CF₂CF₂O)_{b}(CF₂O)_{c}(CF(CF₃)O)_{d}—

wherein a, b, c, d are 0 or integers selected in such a way as chain R_{f} meets the above number average molecular weight requirement; with the proviso that, at least one of a, c and d is not 0; when b is other than 0, a/b is preferably between 0.1 and 10; when (a+b) is different from 0 (c+d)/(a+b) preferably is between 0.01 and 0.5, more preferably between 0.01 and 0.2;

(R_{f}-c)—(CF₂CF(CF₃)O)ₑ(CF₂O)_{f}(CF(CF₃)O)_{g}—

wherein e, f, g are 0 or integers selected in such a way as chain R_{f} meets the above number average molecular weight requirement; when e is other than 0, (f+g)/e is preferably between 0.01 and 0.5, more preferably between 0.01 and 0.2.

PFPE polymers wherein chain (R_{f}) complies with formula (R_{f}-a) as defined above, wherein p and q are 0, are particularly preferred in the present invention.

In a preferred embodiment, said PFPE polymer complies with the following formula (PFPE-I):

HO—(CH₂CH₂O)ₜ—CH₂-(R_{pf})—CH₂(OCH₂CH₂)ᵤ—OH (PFPE-I)

wherein

t and u are, each independently, 0 or from 1 to 5; and

R_{pf} is as defined above.

Preferably, said PFPE polymer has an average number molecular weight of from 400 to 10,000 Da, more preferably from 1,000 to 5,000.

In a preferred embodiment, the molar ratio between monomers (a) and monomers (b) is from 2 to 20, more preferably from 2 to 10.

In a preferred embodiment, the amount of monomers (b) is such that the

F-TPU polymer comprises from 4 to 30 wt. % of fluorine.

Preferably, said at least one monomer (c) has a number molecular weight of 500 Da or lower, preferably from 10 to 500 Da.

Preferably, said at least one monomer (c) is selected in the group comprising, preferably consisting of, 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyana- te, hexamaethylen-diisocyanate, isophorone-diisocyanate, 4,4′-dicyclohexyl-methane-diisocyanate and cyclohexyl-1,4-diisocyanate.

MDI and HDI being particularly preferred.

Preferably, said at least one monomer (d) is selected in the group comprising, preferably consisting of, ethylene-glycol, 1,4-butanediol (BDO), 1,6-hexane diol (HDO), N,N-diethanolamine and N,N-diisopropanolaniline. BDO and HDO being particularly preferred.

In a preferred embodiment, the sum of blocks deriving from monomers (c) and (d) is from 10 to 60 wt. % based on the total weight of the F-TPU polymer.

Those skilled in the art would readily understand that blocks comprising recurring units derived from monomers (a) and (b) are rubber-like blocks, while blocks comprising recurring units derived from monomers (c) and (d) are hard blocks.

In a preferred embodiment, at least 80% of the blocks comprising recurring units derived from said monomers (b) [blocks B] are linked, at least one of their ends, to a block comprising recurring units derived from monomers (a) [blocks A] through a block comprising recurring units derived from monomers (c) [blocks C].

In other words, at least 80% of blocks B are contained in a sequence of the following type: -[A-C-B-C]-.

Advantageously, the F-TPU polymer can be prepared following the procedures disclosed in U.S. Pat. No. 5,332,798 (AUSIMONT S.P.A.) , in particular in Example 15.

According to a preferred embodiment, the case according to the present invention is made from a composition (C) that is free of plasticizer agents.

Preferably, said composition (C) comprises the F-TPU polymer as defined above as the main component.

More preferably, said F-TPU polymer is in an amount of at least 60 wt. %, more preferably at least 80 wt. %, even more preferably at least 85 wt. % based on the total weight of said composition (C).

In addition to the F-TPU polymer, said composition (C) can optionally comprise further additives, such as for example antioxidants, thermal stabilizers, dyestuffs and fillers.

Embodiments wherein said composition (C) is essentially made of said

F-TPU polymer in combination with an amount of up to 1 wt. % of any of the additives listed above are also encompassed by the present invention.

According to a first embodiment, the case according to the present invention comprises a back panel and a plurality of sidewalls, preferably four sidewalls, extending from said back panel, such that the back panel and the sidewalls define a storage volume for and holding the portable device.

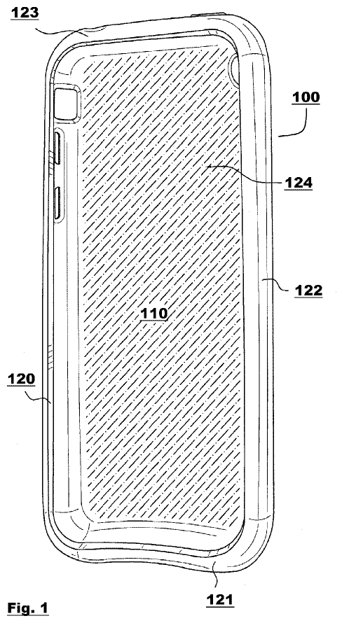

With reference to FIG. 1, case (100) comprises back wall (110) and four sidewalls (120, 121, 122, 123), which define an interior having an interior surface (124) and configured to receive a portable electronic device (not represented in FIG. 1).

According to a second embodiment, the case according to the present invention comprises peripheral edges, having an inner surface shaped for receiving and holding the edges of a portable device.

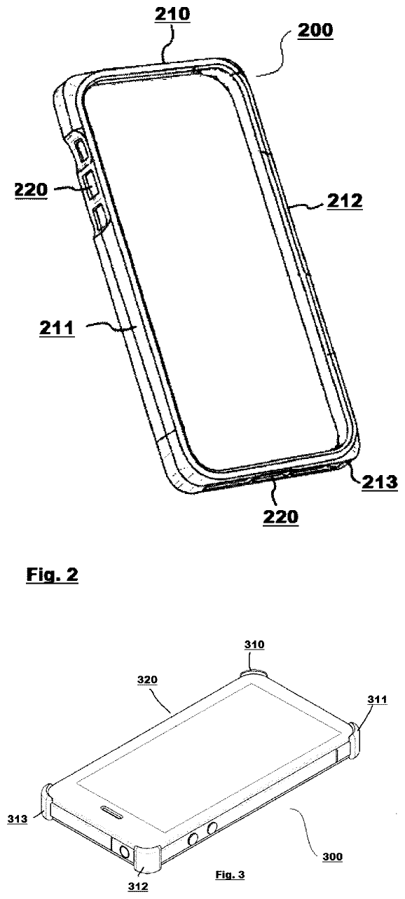

With reference to FIG. 2, case (200) comprises only four opposing sidewalls (210, 211, 212, 213), which define an internal empty space configured to receive a portable electronic device (not represented in FIG. 2), and a plurality of holes (220), which provide access to portions of the portable electronic device, such as volume control(s), headphone port(s), speaker(s), on/off control(s) and the like.

According to a third embodiment, the case according to the present invention is in the form of one or more element, configured to be adapted to the corners of the portable electronic device.

With reference to FIG. 3, case (300) comprises four elements (310, 311, 312, 313) configured to be positioned at the corners of the portable electronic device (320).

The case according to the present invention has mechanical properties is sufficiently stretchable and resilient such that even when stretched it returns towards its original shape.

According to a first embodiment, the case according to the present invention comprises only one layer [layer L1] made from composition C as defined above.

According to another preferred embodiment, the case according to the present invention comprises layer L1, having an internal surface and an external surface, wherein at least one surface, preferably the external surface, is coupled with a thermo-formed layer [layer 0] made from a hard plastic. Advantageously, said layer 0 contributes to the overall rigidity of the case and to the protection of the portable electronic device hold by the case.

The skilled person will understand that the case (100, 200, 300) according to the present invention can be manufactured in different shapes and/or dimensions, in order to hold portable electronic devices having different dimensions, such as for example smartphones, tablets and laptop computers.

The case according to the present invention can be manufactured following methods known in the art.

As an example, the case can be manufactured by a process comprising the following steps:

(i) providing a mould;

(ii) filling said mould with a composition comprising at least one elastomeric fluorinated polyurethane [F-TPU polymer] as defined above;

(iii) sealing the mould;

(iv) heat treating the sealed mould; and

(v) extracting the case from the mould.

Preferably, step (iv) comprises two steps, wherein the first step comprises heating at a first temperature for a time from 10 seconds to 10 minutes and the second step comprises heating at a second temperature, said second temperature being lower than said first temperature, for a time of from 30 seconds to 24 hours.

More preferably, said first temperature is from 120° C. to 300° C.

More preferably, said second temperature is from 50° C. to 200° C.

Alternatively, step (iv) comprises only one step of heating at a temperature of from 50° C. to 300° C. for a time of from 10 seconds to 24 hours.

Preferably, after step (iv) and before step (v), the mould is allowed to cool down.

It will be apparent to the skilled person that the shape and the dimensions of the mould are not limitative and can be properly selected depending on the desired shape and dimension of the case.

Should the disclosure of any patents, patent applications, and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### Experimental Section

Materials

Monomers (a):

(a1) CAPA™ 2201 (from Perstorp) polycaprolactone-diol (PLC) having molecular weight (Mw) of about 2,000 and —OH value of about 56 mg KOH/g;

(a2) polytetramethyleneglycol (PTMEG) having Mw of about 2,000

(a3) ETERNACOLL® UH200 (from UBE) polycarbonate-diol (PCD) having Mw of about 2,000

(a4) BESTER™ (from DOW) polyester-diol having Mw of about 2,000

Monomers (b) having formula:

H(OCH₂CH₂)ₚOCH₂CF₂O(CF₂CF₂O)ₘ(CF₂O)ₙCF₂CH₂O(CH₂CH₂O)ₚH

(b1) p=4.7 and Mw of about 2,000

(b2) p=1.6 and Mw of about 1,700

Monomers (c):

(c1) diphenylen-4,4′-diisocyanate (MDI)

(c2) 1,6-hexan-diisocyanate (HDI)

Monomers (d):

(d1) 1,4-butanediol (BDO)

(d2) 1,6-hexandiol (HDO)

Catalyst:

bismuth neodecanoate

Preparation of F-TPU Polymer Specimens—Method A

F-TPU polymer specimens 1 to 4 in the form of sheet were prepared starting from the abovementioned monomers following the same procedure detailed in Example 15 of U.S. Pat. No. 5,332,798 (to Ausimont S.p.A.) cited above.

F-TPU polymers thus obtained contained 20 wt. % of recurring units derived from monomers (b).

Preparation of F-TPU Polymer Specimens—Method B

F-TPU polymer specimens 5 to 8 in the form of sheet were prepared as follows:

the hydrogenated pre-polymer was synthetized by reacting monomer (c) and monomer (a) in the equivalent ratio 2 to 1, at a temperature of 90° C.;

the fluorinated pre-polymer was synthetized by reacting monomer (c) and monomer (b) in the equivalent ratio 2 to 1, at a temperature of 90° C.;

the hydrogenated pre-polymer and the fluorinated pre-polymer were then mixed together and stirred at 90° C. for 30 minutes;

monomer (c) was further added depending on the selected stoichiometry;

the reaction was continued at 90° C. for 3 minutes until chain-extension was completed;

the polymer thus obtained was casted at 100° C. for 24 hours.

The compositions of the F-TPU polymers obtained following methods A and B described above and the compositions of comparative hydrogenated polyurethane polymers (H-TPU) are reported in the following Table 1.

As further comparison, a commercially available hydrogenated TPU (H-TPU 9*) was used. The monomers ratio for H-TPU 9* is not publicly available.

TABLE 1

| | Monomers (molar ratio) | | | | | | | | | |
|---|---|---|---|---|---|---|---|---|---|---|
| | a1 | a2 | a3 | a4 | b1 | b2 | c1 | c2 | d1 | d2 |
| F-TPU 1 | 0.8 | — | — | — | 0.2 | — | 2.0 | — | 1.0 | — |
| F-TPU 2 | — | 0.7 | — | — | 0.3 | — | 3.0 | — | 2.0 | — |
| F-TPU 3 | — | 0.6 | — | — | — | 0.4 | 2.5 | — | 1.5 | — |
| F-TPU 4 | — | — | — | 0.75 | 0.25 | — | — | 2.0 | — | 1.0 |
| F-TPU 5 | 0.75 | — | — | — | — | 0.25 | — | 3.0 | 2.0 | — |
| F-TPU 6 | — | — | 0.75 | — | — | 0.25 | — | 2.0 | 1.0 | — |
| F-TPU 7 | 4.0 | — | — | — | — | 0.3 | — | 0.7 | 3.0 | — |
| H-TPU | — | 1.0 | — | — | — | — | 2.0 | — | 1.0 | — |
| 8(*) | | | | | | | | | | |
| H-TPU | n/a | — | — | — | — | — | — | n/a | n/a | — |
| 9(*) | | | | | | | | | | |

(*)comparison
n/a = value not available

The mechanical properties of sheets made from F-TPU and H-TPU polymers were evaluated and the results are reported in Table 2.

TABLE 2

| | | Tensile strength | Elongation at |
|---|---|---|---|
| | Shore A | (MPa) | break (%) |
| F-TPU 1 | 85 | 28.1 | 471 |
| F-TPU 2 | 93 | 31 | 410 |
| F-TPU 3 | 80 | 35 | 400 |
| F-TPU 4 | 75 | 7.30 | 590 |
| F-TPU 5 | 90 | 26.1 | 505 |
| F-TPU 6 | 83 | 13 | 550 |
| F-TPU 7 | 91 | 31.8 | 506 |
| H-TPU 8(*) | 78 | 40 | 550 |

(*)comparison

The above results show that the F-TPU polymers according to the present invention have mechanical properties comparable with the mechanical properties of H-TPU polymers typically used in the production of the case for portable electronic devices, and hence F-TPU polymers provide good mechanical properties to the case.

The sheets were used in the Examples described hereinafter.

### EXAMPLE 1

### Contact Angle

This test is considered to be predictive for both stain and chemical resistance.

The static contact angle (SCA) of a sessile drop (about 5 μL) of water and n-hexadecane as solvents was measured with the DSA30 instrument (Krüss GmbH, Germany). The SCA values as well as standard deviations were calculated among ten contact angles.

Surface free energy (SFE) was calculated following the Owens, Wendt, Rabel and Kaelble method (WORK method), which is a standard method for calculating the surface free energy of a solid from the contact angle with several liquids.

The results are summarized in the following Table 3.

TABLE 3

| Sample | SCA H₂O | SCA C₁₆ | SFE (mN/m) |
|---|---|---|---|
| F-TPU 1 | 104 | 64.5 | 16.1 |
| F-TPU 2 | 110.5 | 63.6 | 15.09 |
| F-TPU 3 | 106.7 | 62.9 | 15.90 |
| F-TPU 4 | 86 | 61 | 23.6 |
| F-TPU 5 | 105 | 68 | 14.9 |
| F-TPU 6 | 103 | 66 | 16 |
| F-TPU 7 | 98 | 70 | 16.9 |
| H-TPU 8(*) | 77 | 46 | 30.93 |
| H-TPU 9(*) | 81 | 29 | 31.7 |

(*)comparison
SCA = Static Contact Angle
H₂O = water
C₁₆ = hexadecane
SFE = Surface Free Energy

The above results show that the contact angle measured with both water (H₂O) and hexadecane (C₁₆) increased while the surface energy dropped down to the range from 15 to 16 mN/m compared to 31 mN/m for the hydrogenated thermoplastic polyurethane used as reference compound. These data are consistent with an increase in terms of stain resistance and chemical resistance conferred by the F-TPUs compared to H-TPU.

### EXAMPLE 2

### Blue Denim Test

This test is considered to be predictive for both staining and abrasion resistance.

The test was performed with the instrument Taber Industries 5750 Linear

Abraser, that was set to run at the following conditions:

cycle speed: 30 cycles/min

stroke length: 2.54 cm (1 inch)

number of cycles: 200

total load: 1 kg.

Tests were performed once with dry denim and once with wet denim on F-TPU 1, F-TPU 2, F-TPU 3, F-TPU 5 and F-TPU 7.

Before performing the test with wet denim, denim was submerged in water for 10 second, then it was removed and water was squeezed out by hand so that denim did not drip but was wet to the touch.

The tests were performed as follows: a denim sample measuring approximately 30 mm×30 mm was fixed to a fixture in order to prevent shifting of the sample during the test. A sample of each F-TPU and of H-TPU was then placed on the denim sample and fixed to the fixture as well.

Checkpoints were set as follows:

after rub and

after cleaning with isopropyl-alcohol (IPA).

Results for the dry test: no stain was observed for F-TPU 1, F-TPU 2, F-TPU 3, F-TPU 5 and F-TPU 7.

Results for the wet test: a very light halo was observed for F-TPU 1, F-TPU 2, F-TPU 3, F-TPU 5 and F-TPU 7.

### EXAMPLE 3

### Stain Test

A drop of each staining agent listed above was put into contact with the surface of a specimen made from F-TPU 1 and let for 24 hours at ambient conditions. The specimen was then cleaned with water.

A specimen made from H-TPU was used as comparison and treated as disclosed above.

The results are summarized in the following Table 4, wherein:

++=no stain

+=mark/halo

−=stain

TABLE 4

| Staining agent | H-TPU(*) | F-TPU 1 |
|---|---|---|
| Olive oil | − | ++ |
| Ketchup | + | ++ |
| Hot coffee | − | + |
| Mayonaise | − | ++ |
| Coca Cola | − | ++ |
| Mustard | − | + |
| Vinager | ++ | ++ |
| Windex ® cleaner | + | + |
| Formula 409 ® cleaner | + | + |
| Purell ® hand sanitizer | − | ++ |
| Vaseline intensive care lotion | − | ++ |
| Alcohol | − | ++ |

(*)comparison

The above results clearly showed the increase in term of both stain and chemical resistance of the F-TPU specimen compared to the H-TPU specimen.

### EXAMPLE 4

### Evaluation of Haptic Properties

The haptic properties (notably the feeling of softness) of F-TPUs and the

H-TPUs were measured by testing the sheets of the materials subjectively by hand feel of 5 individuals.

Soft feel was measured subjectively by hand touch and rated on a scale from 1 to 5, with 1 being poor soft feel (hard feel) and 5 being excellent soft feel. Participants took part in this study individually, so they did not influence each other in their responses. Participants were presented with the four samples in a random order and asked to feel and rate them.

The results are summarized in the following Table 5.

TABLE 5

| | Rating | | | | | |
|---|---|---|---|---|---|---|
| | Individ- | Individ- | Individ- | Individ- | Individ- | |
| Sample | ual 1 | ual 2 | ual 3 | ual 4 | ual 5 | Average |
| F-TPU 1 | 4 | 5 | 4 | 4 | 5 | 4.4 |
| F-TPU 2 | 5 | 5 | 5 | 4 | 5 | 4.8 |
| F-TPU 3 | 5 | 4 | 4 | 4 | 4 | 4.2 |
| F-TPU 4 | 5 | 5 | 5 | 4 | 5 | 4.8 |
| F-TPU 5 | 5 | 4 | 4 | 3 | 4 | 4.0 |
| F-TPU 6 | 5 | 4 | 5 | 4 | 4 | 4.4 |
| F-TPU 7 | 4 | 4 | 4 | 4 | 5 | 4.2 |
| H-TPU | 2 | 1 | 1 | 1 | 2 | 1.4 |
| 8(*) | | | | | | |
| H-TPU | 2 | 2 | 1 | 1 | 2 | 1.6 |
| 9(*) | | | | | | |

(*)comparison

The above results clearly showed that the sheets obtained with the F-TPUs according to the present invention showed better haptic properties, notably improved feeling of softness, when compared to sheets obtained from H-TPU polymers.

1. A case (100, 200, 300) configured to hold a mobile media device, said case being made from a composition (C), wherein composition (C) comprises at least one F-TPU polymer, wherein F-TPU polymer is a fluorinated polyurethane comprising recurring units derived from:
monomer (a), wherein monomer (a) is at least one diol selected from the group comprising poly-ether type diol, poly-ester type diol, polybutadien-diol and polycarbonate-diol;
monomer (b), wherein monomer (b) is at least one hydroxy-terminated (per)fluoropolyether polymer;
monomer (c), wherein monomer (c) is at least one aromatic, aliphatic or cycloaliphatic diisocyanate; and
monomer (d), wherein monomer (d) is at least one aliphatic, cycloaliphatic or aromatic diol having from 1 to 14 carbon atoms.

2. The case according to claim 1, wherein said at least one monomer (a) is selected from the group consisting of poly(ethylene)glycol, poly(propylene)glycol, poly(tetramethylen)glycol (PTMG), poly(1,4-butanediol)adipate, poly(ethandiol-1,4-butanediol) adipate, poly(1,6-hexandiol-neopentyl)glycol adipate, poly-caprolactone-diol (PCL) and polycarbonate-diol.

3. The case according to claim 1, wherein said at least one monomer (b) is a hydroxy-terminated (per)fluoropolyether polymer comprising a (per)fluoropolyoxyalkylene chain (R_{pf}) having two chain ends, wherein one or both chain ends terminates with at least one —OH group.

4. The case according to claim 3, wherein at least one chain end of said chain (R_{pf}) terminates with a group of formula (I):
—CH₂(OCH₂CH₂)ₜ—OH (I)
wherein
t is 0 or from 1 to 5.

5. The case according to claim 3, wherein both chain ends of said chain (R_{pf}) terminate with a group of formula (I):
—CH₂(OCH₂CH₂)ₜOH (I)
wherein
t is 0 or from 1 to 5.

6. The case according to claim 3, wherein said chain (R_{pf}) is a chain of formula
—O-D-(CFX^{#})_{z1}—O(R_{f})(CFX^{*})_{z2}-D*-O—
wherein
z1 and z2, equal or different from each other, are equal to or greater than 1; X^{#} and X*, equal or different from each other, are —F or —CF3, provided that when zl and/or z2 are greater higher than 1, X^{#} and X* are —F;
D and D*, equal or different from each other, are an alkylene chain comprising from 1 to 6 carbon atoms, said alkyl chain being optionally substituted with at least one perfluoroalkyl group comprising from 1 to 3 carbon atoms;
(R_{f}) comprises repeating units R°, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}T, wherein R_{(f-a)} is a fluoropolyoxyalkene chain comprising a number of repeating units from 0 to 10, said recurring units being chosen from:
—CFXO—, —CF₂CFXO—, —CF₂CF₂CF₂O—, and —CF₂CF₂CF₂CF₂O—, with each of each of X being independently F or CF₃ and T being a C₁—C₃ perfluoroalkyl group.

7. The case according to claim 6, wherein said chain (R_{f}) is selected from the following formulae (R_{f}-a) to (R_{f}-c):
(R_{f}-a) —(CF₂O)ₙ(CF₂CF₂O)ₘ(CF₂CF₂CF₂O)ₚ(CF₂CF₂CF₂CF₂O)_{q}—
wherein m, n, p, q are 0 or integers selected in such a way as chain R_{f} meets the above number average molecular weight requirement, with the proviso that, if p and q are simultaneously 0, n is not 0;
(R_{f}-b) —(CF₂CF(CF₃)O)ₐ(CF₂CF₂O)_{b}(CF₂O)_{c}(CF(CF₃)O)_{d}—
wherein a, b, c, d are 0 or integers selected in such a way as chain R_{f} meets the above number average molecular weight requirement; with the proviso that, at least one of a, c and d is not 0;
(R_{f}-c) —(CF₂CF(CF₃)O)ₑ(CF₂O)_{f}(CF(CF₃)O)_{g}—
wherein e, f, g are 0 or integers selected in such a way as chain R_{f} meets the above number average molecular weight requirement.

8. The case according to claim 1, wherein said hydroxy-terminated (per)fluoropolyether polymer complies with the following formula (PFPE-I):
HO—(CH₂CH₂O)ₜ—CH₂—(R_{pf})—CH₂(OCH₂CH₂)ᵤ—OH (PFPE-I)
wherein
t and u are, each independently, 0 or from 1 to 5; and
R_{pf} is a chain of formula
—O-D-(CFX^{#})_{z1}—O(R_{f})(CFX^{*})_{z2}-D*-O—
wherein
z1 and z2, equal or different from each other, are equal to or greater than 1, X^{#} and X*, equal or different from each other, are —F or —CF3, provided that when z1 and/or z2 are greater than 1, X^{#} and X* are —F,
D and D*, equal or different from each other, are an alkylene chain comprising from 1 to 6 carbon atoms, said alkyl chain being optionally substituted with at least one perfluoroalkyl group comprising from 1 to 3 carbon atoms;
(r_{f}) comprises repeating units R°, said repeating units being independently selected from the group consisting of:
—CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen from: —CFXO—, —CF₂CFXO—, —CF₂CF₂CF₂O—, and —CF₂CF₂CF₂CF₂O—, with each of each of X being independently F or CF₃ and Tbeing a C₁—C₃ perfluoroalkyl group.

9. The case according to claim 1, wherein said at least one monomer (c) is selected from the group consisting of 4,4-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamethylen-diisocyanate, isophorone-diisocyanate, 4,4-dicyclohexyl-methane-diisocyanate and cyclohexyl-1,4-diisocyanate.

10. The case according to claim 1, wherein said at least one monomer (d) is selected from the group consisting of ethylene-glycol, 1,4-butanediol (BDO), 1,6-hexane diol (HDO), N,N-diethanolamine and N,N-diisopropanolaniline.

11. The case according to claim 1, wherein at least 80% of blocks comprising recurring units derived from said monomers (b) are linked, on at least one of their ends, to a block comprising recurring units derived from monomers (a) through a block comprising recurring units derived from monomers (c).

12. The case according to claim 1, wherein said composition (C) is free of plasticizer agents.

13. The case according to claim 1, wherein said composition (C) comprises said F-TPU polymer in an amount of at least 60 wt. % based on the total weight of said composition (C).

14. A process for manufacturing a case as defined in claim 1, said process comprising the following steps:
(i) providing a mould;
(ii) filling said mould with a composition (C) comprising at least one F-TPU polymer;
(iii) sealing the mould;
(iv) heat treating the sealed mould; and
(v) extracting the case from the mould.

15. The case according to claim 6, wherein D and D*, equal or different from each other, are an alkylene chain comprising from 1 to 3 carbon atoms, said alkyl chain being optionally substituted with at least one perfluoroalkyl group comprising from 1 to 3 carbon atoms.

16. The case according to claim 6, wherein (R_{f}) consists of repeating units R°.

17. The case according to claim 7, wherein:
when m is other than 0, the m/n ratio is between 0.1 and 20;
when (m+n) is other than 0, (p+q)/(m+n) is between 0 and 0.2;
when b is other than 0, a/b is between 0.1 and 10;
when (a+b) is different from 0, (c+d)/(a+b) is between 0.01 and 0.5; or
when e is other than 0, (f+g)/e is between 0.01 and 0.5.
